(19) United States
(12) Patent Application Publication
(10) Pub. No.: US 2023/0029830 A1
(43) Pub. Date: Feb. 2, 2023

(54) System and Method for Electric Vehicle Charger use in Non-Charging Mode

(71) Applicant: Rhombus Energy Solutions, Inc., San Diego, CA (US)

(72) Inventors: Joseph Gottlieb, Poway, CA (US); Anil Tuladhar, Canton, MI (US)

(21) Appl. No.: 17/815,559

(22) Filed: Jul. 27, 2022

Related U.S. Application Data
(60) Provisional application No. 63/226,152, filed on Jul. 27, 2021.

(51) Int. Cl. B60L 53/30; H02J 7/04; H02M 1/42; H02M 1/12; B60L 53/62

(52) U.S. Cl. CPC B60L 53/30; H02J 7/04; H02M 1/4208; H02M 1/12; B60L 53/62; H02J 2207/20; B60L 2210/30

(57) ABSTRACT

A system and method of a multi-channel, multi-mode electric vehicle (EV) AC to DC charger has power channels, each power channel contains an AC/DC converter and corresponding DC/DC regulator. Each channel is configured to supply DC power to a channel-connected EV. The charger also has a controllable bridging switch, connected in parallel between the power channels and disposed before or after the DC/DC regulators, and provides an intermediary path between the power channels. It also contains controllable series switches, after the DC/DC regulators to provide a break in a power channel output path. A controller controls the AC/DC converters, DC/DC regulators, bridging and series switches. The charger is multi-mode capable, enabling (a) charging an EV, (b) directing power from one channel's connected end device to another channel's connected end device, (c) injecting real or reactive power back to an AC power source, (d) active AC filtering, and (d) phase balancing.

### CROSS-REFERENCE TO RELATED APPLICATION(S)

This application claims the benefit of U.S. Provisional Patent Application No. 63/226,152, filed Jul. 27, 2021, titled “Electric Vehicle (EV) Charger use in Non-Charging Mode,” the contents of which are hereby incorporated by reference in its entirety.

### FIELD

This invention is directed to an alternative use of an Electric Vehicle (EV) charger when not “connected” to an EV. Specifically, to provide support services (e.g., reactive power) and so forth.

### BACKGROUND

Typical electric vehicle chargers are only active when a vehicle is plugged in to charge. When a vehicle is not plugged in, they are usually in a sleep mode trying to conserve energy. Currently, there is no utilization of the EV charger system or resident electronics when not charging (or discharging). Even in a vehicle-to-grid connected mode, the charger is only actively pushing (or pulling) power when the EV is connected.

In view of the above, various systems and methods are presented below use the resident power electronics of the EV charger when an EV is not “connected” for alternative power uses.

### SUMMARY

The following presents a simplified summary in order to provide a basic understanding of some aspects of the claimed subject matter. This summary is not an extensive overview, and is not intended to identify key/critical elements or to delineate the scope of the claimed subject matter. Its purpose is to present some concepts in a simplified form as a prelude to the more detailed description that is presented later.

In one aspect of the disclosed embodiments, a multi-channel, multi-mode electric vehicle (EV) AC to DC charger is provided, comprising: at least two power channels, each power channel containing an AC/DC converter connected to a corresponding DC/DC regulator, wherein each channel is configured to supply DC power to a connected EV; a controllable bridging switch, connected in parallel between the at least two power channels and disposed before or after the DC/DC regulators, and when closed provides an intermediary path between the at least two power channels; controllable series switches, connected directly or indirectly after the DC/DC regulators of a respective power channel, and when open provides a break in a power channel output path; and a controller controlling at least the AC/DC converters, DC/DC regulators, bridging and series switches, wherein by action of the controller and switches' engagement, the charger can perform at least one of: (a) charging a connected EV, (b) directing power from one channel's connected end device to another channel's connected end device, (c) injecting real or reactive power back to an AC power source, (d) active AC filtering, and (e) phase balancing.

In another aspect of the disclosed embodiments, the above system is provided, further comprising, a controllable multipole switch terminating each power channel of the at least two power channels and is controlled by the controller to connect a power channel to its respective EV charging cable or a power channel to a non-EV device; and/or wherein each controllable multipole switch is configured to connect between a non-EV connected channel end device to another non-EV connected channel end device; and/or wherein the AC/DC converter and DC/DC regulator are a single system; and/or wherein the controller is external to at least one of the AC/DC converter and DC/DC regulator; and/or wherein there is a controller for each channel; and/or further comprising, a Line Filter forward of the AC/DC converters; and/or a Grid, the Grid coupling AC power to a front end of the charger; and/or, a reactive power generated from at least an AC converter of at least two power channels, the reactive power being fed into the Grid; and/or a connection to a point of common coupling (PCC) between the Grid and the charger; and/or at least one of a non-linear load and unbalanced load connected to the PCC; and/or at least one of a reactive power and phased power generated from the at least an AC converter of the at least two power channels, the reactive power being fed into the least one non-linear load and unbalanced load; and/or a set of controller software instructions to generate reactive power, the instructions containing modules for: calculating a required total reactive power (Q); adding a reactive power increment (deltaQ) from a reactive power regulator to obtain a modified reactive power (Q′); evaluating channel operation status and reactive power levels; adjusting the modified reactive power (Q′) if needed; comparing the modified reactive power (Q′) or the adjusted Q′ to a measured or calculated reactive power value; and sending a signal to the reactive power regulator based on the comparing, to generate a next deltaQ.

In yet another aspect of the disclosed embodiments, a method of providing grid-services from a multi-channel, multi-mode electric vehicle (EV) DC charger is provided, comprising: controlling a charger having at least two power channels, each power channel containing an AC/DC converter connected to a corresponding DC/DC regulator, wherein each channel is configured to supply DC power to a connected EV; controlling a bridging switch, connected in parallel between the at least two power channels and disposed before or after the DC/DC regulators, and when closed provides an intermediary path between the at least two power channels; controlling series switches, connected directly or indirectly after the DC/DC regulators of a respective power channel, and when open provides a break in a power channel output path; and at least one of: (a) charging a connected EV, (b) directing power from one channel's connected end device to another channel's connected end device, (c) injecting real or reactive power back to an AC power source, (d) active AC filtering, and (e) phase balancing.

In yet another aspect of the disclosed embodiments, the above method is provided, further comprising, a controlling a multipole switch terminating each power channel of the at least two power channels, wherein the multipole switch operates to connect a power channel to its respective EV charging cable or a power channel to a non-EV device; and/or further comprising, connecting via the multipole switch a non-channel connected end device to another non-channel connected end device; and/or further comprising, feeding a reactive power generated from at least an AC converter of at least two power channels, into an AC source; and/or further comprising, coupling the charger and at least one of a non-linear load and unbalanced load connected to a point of common coupling (PCC); and/or further comprising, feeding at least one of a reactive power and phased power generated from the at least an AC converter of the at least two power channels, into the least one non-linear load and unbalanced load; and/or further comprising: calculating a required total reactive power (Q); adding a reactive power increment (deltaQ) from a reactive power regulator to obtain a modified reactive power (Q′) evaluating channel operation status and reactive power levels; adjusting the modified reactive power (Q′) if needed; comparing the modified reactive power (Q′) or the adjusted Q′ to a measured or calculated reactive power value; and sending a signal to the reactive power regulator based on the comparing, to generate a next deltaQ.

### BRIEF DESCRIPTION OF THE DRAWINGS

FIG. 1 is a high level block diagram of a Prior Art EV charging system connected to an EV.

FIG. 2 is a high level block diagram of an exemplary EV charging system, with an internal contactor in an off position.

FIG. 3 is a high-level Power Block diagram of an exemplary Dual channel DC Fast Charger system with controllable switching.

FIG. 4 is a high level flow chart showing a possible operational decision process for an exemplary charger system.

FIG. 5 shows a Flow Chart of an exemplary power control methodology for injecting reactive power to help support the Grid, using an exemplary dual charger system.

FIG. 6 is a diagram showing sample signal paths to achieve a step of the process shown in FIG. 5.

FIG. 7 is an illustration of the control structure of the Idq_Regulator of FIG. 6.

FIG. 8 is an illustration of an exemplary charging system with a non-linear load 830.

FIG. 9 is an illustration of an exemplary charging system with an unbalanced load.

FIG. 10 is a high level block diagram showing an exemplary EV charging system operating as a power conduit from a load-side.

### DETAILED DESCRIPTION

The present disclosure describes exemplary systems and methods that use the resident power electronics of the EV charger when an EV is not “connected” for alternative power uses. For example, the exemplary system can provide services to any AC source connected such as Grid, generator, inverter, or any connection providing an AC connection. The AC connection point is a common connection used for both EV charging/discharging and non-EV connected services. Moreover, using a bridging contactor, non-EV DC services can also be provided.

These power services can include:

a. Injecting real or reactive power to help support the Grid

b. Active filtering of the AC

c. Phase balancing

d. As an adjustable DC Power available power Source or Sink

e. Etc.

More specific non-limiting examples of the above are:

a. Reactive power injection can help in at least two forms:
Following the utility volt-var curves as one of the ancillary services.
Maintaining the customer load at near unity power factor, which avoids low power factor penalty and improves overall system efficiency.

b. Active Filtering:
Filter out harmonics to improve power quality and improve overall system efficiency.

c. Phase balancing:
Most 3 phase power equipment do not like unbalanced phases. It can cause excessive heating and stress on electro-mechanical components like motors. Therefore, phase balancing can increase efficiency and prolong the life of such-connected equipment. Phase balancing can be achieved either by injecting negative sequence reactive power (with Support Vector Machine (SVM) control, for example) or using the sine Pulse Width Modulation (PWM) with a mid-point DC cap as the neutral reference.

d. Power Factor Control:
Helps offset poor power factor loads reducing energy consumption and potential utility penalties for low power factor equipment usage.

e. Adjustable DC Power Source or Sink:
DC sources such as fuel cells or PV cells can be connected to one of the channels to support the grid for real power needs.
DC sinks such as loads (including EVs or auxiliary battery banks) can be connected to the other channel to utilize the excess power generated from the renewable sources.
Because utilities are constantly adjusting parameters of the Grid to maintain stability, providing adjustable source or sink helps the utility avoid brownouts or the like.

Other services may be possible, depending on configuration and design choice. The exemplary EV charger contains an AC/DC converter and/or DC/DC convertor and one or more contactor(s) that can disconnect from the EV. It can be by done by software inside the charger, but it could also be an external disconnect (switch or contactor) manually or automatically controlled. One could manually select the charger to not be connected to an EV and only be used for ancillary Grid services like reactive power support and active filtering. Software could also control the connection to the EV and decide not to connect if other utility services are desired.

For safety reasons and to follow the standards set forth by EV charging standards bodies, the output contactor is closed when a car is connected and the device has gone through all the cable safety checks required. The output contactor could also be opened when the EV is connected and completed charging to provide additional non-EV connected services as well.

The ability to achieve the above services arises from the flexible topology of typical EV DC fast chargers, which in the following examples is based on at least two active front-end AC/DC converters and two DC/DC regulators with appropriately added switching. The below exemplary configurations are descriptive of a single system, however, it is understood that multiple systems may be used, both input and/or output, together to provide larger power support capabilities.

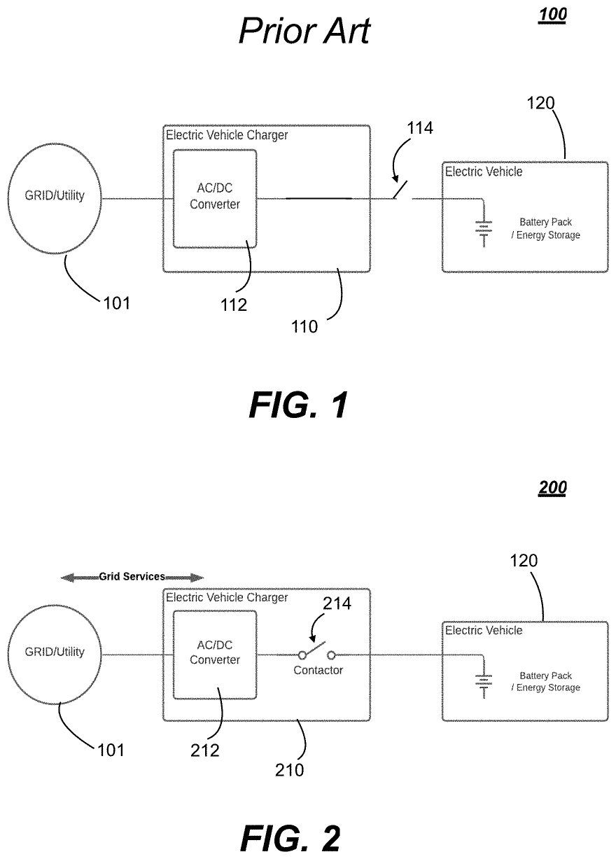

FIG. 1 is a high level block diagram 100 of a prior art EV charging system, showing AC power from Grid 101 being converted to DC for charging a connected EV 120. The conversion is facilitated by 110 charger's AC/DC converter/regulator 112, whose output is switched on or off to the EV 120 via external contactor 114.

FIG. 2 is a concept diagram 200 of an exemplary EV charging system, with an internal contactor 214 in an off position. The EV 120 is disconnected from the charger 210 which is connected to the Grid 101. Here, because the AC/DC converter/regulator 212 does not need to support a non-connected EV 120, the internal circuitry and software can be used to affect the power received from the Grid 101 and be reinjected into the Grid 101 or another device (not shown). Details of such an approach and variations thereof are described in the below FIGS.

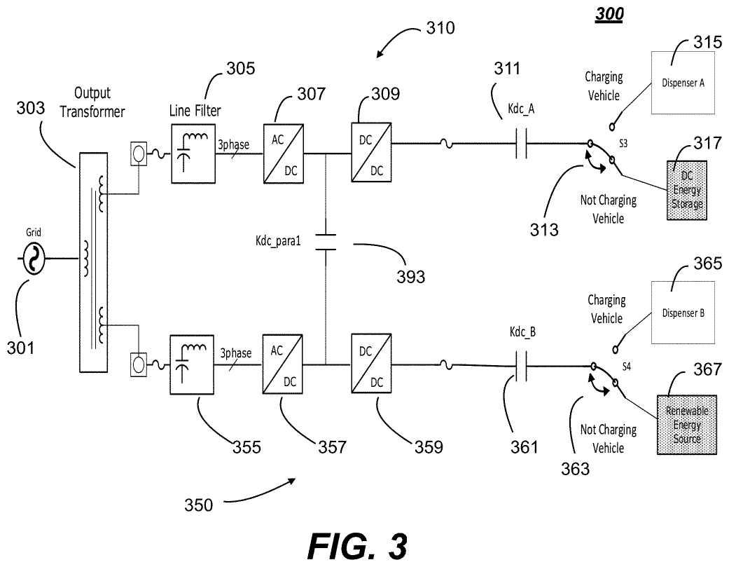

FIG. 3 is a high-level Power Block diagram 300 of an exemplary multi-mode Dual channel DC Fast Charger system with added switching 313, 363 and 393. Because the dual channels 310, 350 are identically connected in parallel (in this example) to Grid power 301, the following explanation of channel A 310's components can be replicated for the “other” channel B 350's components (e.g., 355, 357, 359, 361, 363, 365, etc.).

Typically, in a EV charging mode, Grid power 301 is transformed 303 and line filtered 305 followed by an AC/DC conversion 307. A DC/DC regulation 309 is then performed and the resulting DC is contact switched 311 to dispenser cable 315 via switch 313 which connects to an EV (not shown). In some embodiments, the AC/DC & DC/DC systems may be designed as a single system, to operate as an AC/DC converter-regulator system. The exemplary system has an intermediary switch 313 allows connection to either dispenser cable 315 or to another power source/sink 317 (shown here as connected to the latter 317). Channel B 350's analogous intermediary switch 363 is shown connected to a power source/load 367 and dispenser B's charging cable/EV connector is 365. Switches 311, 361 may be internal to the respective chargers or external, depending on design preference.

It should be understood that the switches 313, 363 may be connected to different other end devices or systems, instead of just the two being shown in this FIG. Further, there may be several of such switches as well as being multi-pole to allow switching to more than two end loads (sources) as well as between end loads (sources). That is, these switches may operate in a mode to completely disconnect the exemplary system's channel(s) from an end device so as to connect one end device to other end device, without connection to a channel. Also, bridging both channels 310 and 350 is another contactor or switch 393 with allows either channel's “load-side” to be connected to each other. The current FIG. shows 3^{rd} switch 393 as aft of the AC/DC converter, but as stated above, in some embodiments the AC/DC converter may be integrated into the DC/DC regulator, thus bridging switch 393 may be placed forward of the AC/DC converter side.

Not shown, but detailed below, is a controller in the charger system that manages the various operations of the AC/DC converters and/or DC/DC regulators as well as the switches. The controller may be separate component or integral to the converters/regulators and may have one or more of the grid services functions implemented through software operating in the controller. Further there may be additional switches or contactors aft of either the Grid power 301, transformer 303, or line filter 305 that provide a shut off or isolation of the Grid power to the charger system. Typically, such shutoffs are implemented as safety controls but may be controlled in the exemplary embodiments for selectively “feeding” power back into the Grid 301 or isolating the Grid side when a non-Grid power service is being engaged.

The above topology provides a flexible and efficient reactive power control capability by allowing running one or both front-end AC/DC converters (or DC/DC) as needed. When a given charger is not charging an EV, the output(s) 313, 363 of the charger can be connected to another source or a battery bank, etc. Also, the two independent channels can be paralleled at the inner DC bus to allow DC coupling of channels A and B by closing contactor 393. This provision enables the “load-side” DC source 367, for example, on Channel B to charge a connected battery 317 on Channel A. Battery 317 can then be used to charge a vehicle (through the other channel B or directly via switch 313) when Grid 301 is not available or the Grid electricity price is very high. For example, the exemplary system is operation in a mode of charging or discharging an auxiliary battery 317 connected to Channel A during non-vehicle charging mode. In that case, the “room” for reactive power injection will be lower (if a 60 kVA system is used, then total kVA per channel will be 60 kVA). If some kVA is used for charging the auxiliary battery 317, the leftover room for the reactive power injection would be less. So, opening either or both of the series contactors 311, 361 would prevent any charging or discharging functions but frees the AC/DC converters 307, 357 to inject or absorb full reactive power to the Grid 301.

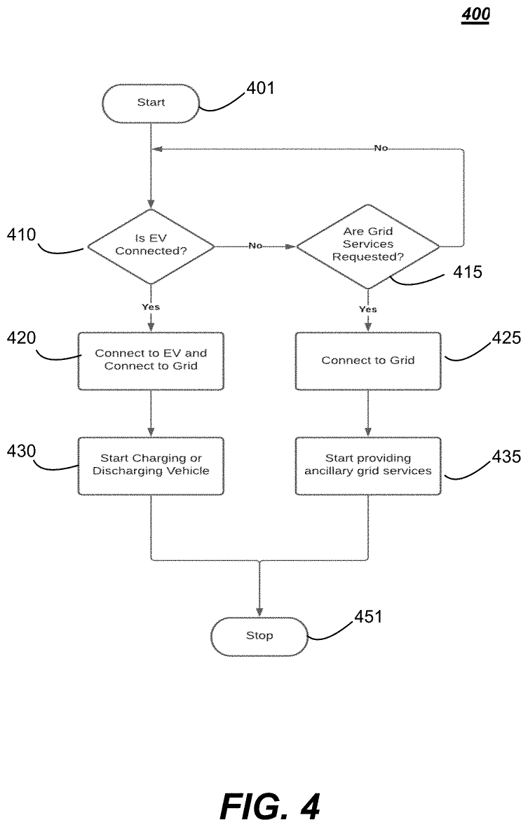

FIG. 4 is a high level flow chart 400 showing a possible operational decision process for an exemplary charger system. Upon start 401, the process checks 410 to see if an EV or source is connected to the charger. If check 410 determines an EV or source is connected, then the process proceeds to connect 420 the EV or source to the Grid-provided power. And charging or discharging is started 430. Upon completion of charging or discharging, the process stops 451.

In step 410, if no EV or source is connected, then the process determines if Grid-like services 415 are requested. If the answer is yes, then the process proceeds to connect the charger 425 to the Grid and proceed to provide the requested ancillary power services 435.

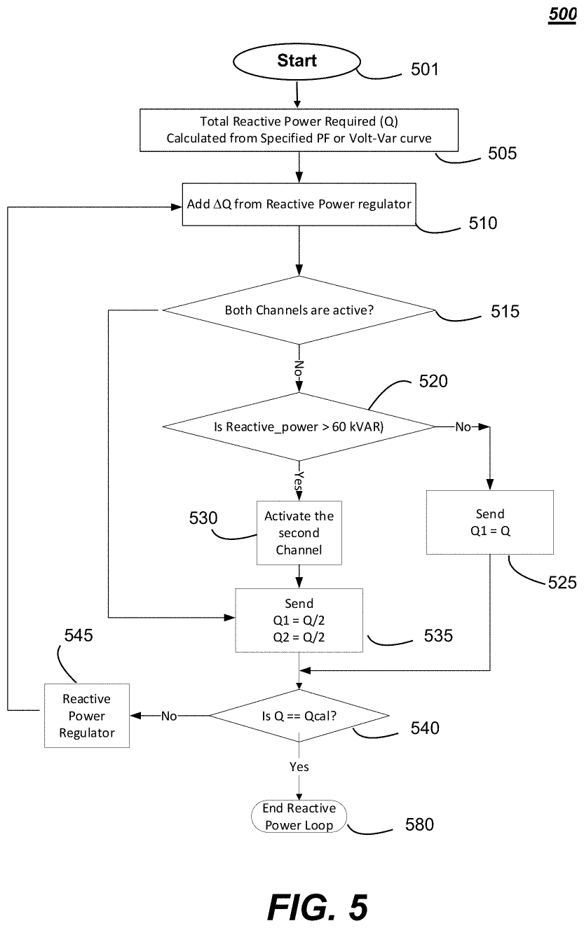

For one of the many possible power services, FIG. 5 shows a Flow Chart 500 of an exemplary power control methodology for injecting reactive power (Q) to help support the Grid, using an exemplary dual charger system. This process can occur when an EV is not being charged. The process starts 501 with step 505 which determines total Q required to support the Grid, as calculated from a power factor or volt-var curve. This Q is the desired reactive power which is commanded to the Grid or a user. Next, step 510 adds deltaQ to the present Q value, as needed, to result in a Q′ Next, step 515 checks to see if both channels are active, and if yes, then proceeds to step 535 which halves the Q′ into Q1 (reactive command to channel A) & Q2 (reactive command to channel B) values. If both channels are not active in step 515, then a Q′>threshold test is performed in step 520—here, the threshold is set to 60 kVAR, but may be different upon the system and design parameters. If Q′ has not exceeded the threshold in step 520, then Q1 is set to Q′ in step 525 and forwards to step 540. If Q′ has exceeded the threshold in step 530, then the second channel is activated and proceeds to step 535 to halve the Q′ into Q1 (channel A) & Q2 (channel B) values. Next, step 540 tests to see if the resulting Q′ from the above steps matches Qcal (calculated or measured reactive power to/from the Grid). If the Qs match or within a given tolerance, then the process terminates 580. If the Qs do not match, then a deltaQ is generated from Reactive Power Regulator 545, for injection into step 510. The process repeats until step 540 is satisfied.

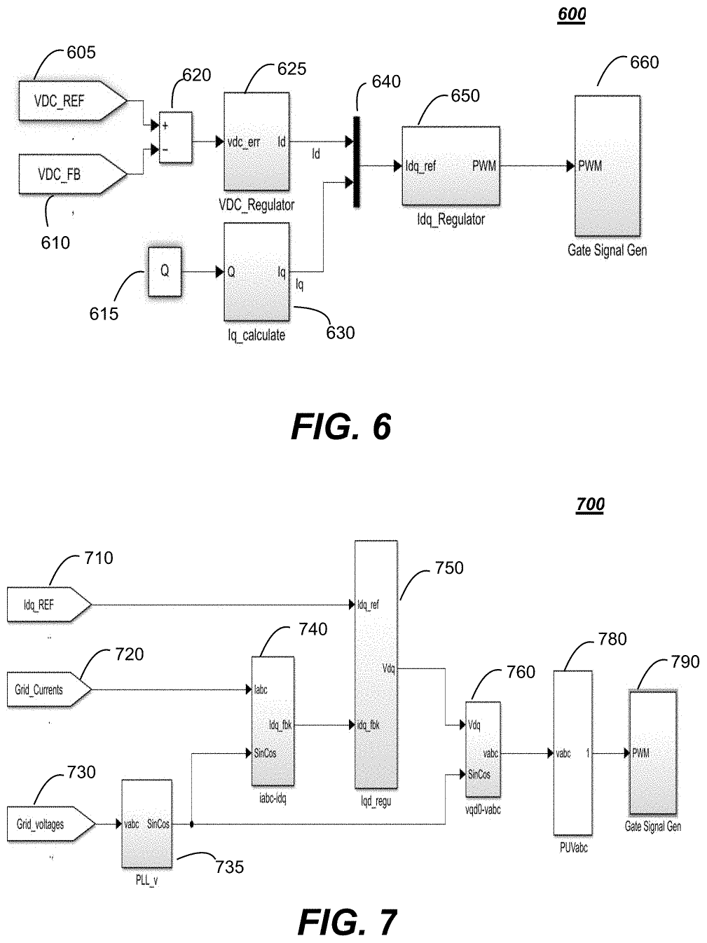

FIG. 6 is a diagram 600 showing sample signal paths to achieve a step of the process shown in FIG. 5. For example, the reactive power command discussed in step 545 in FIG. 5 is accomplished through the outermost control loop (Q signal) as shown below. In essence, the Grid side sinusoidal currents are transformed into two DC quantities (the direct axis component Id and quadrature axis component Iq) through Clark and Park transformations for control purposes. It implements a VDC loop to generate and Id command and Q to generate an Iq command, for reactive power regulation.

To obtain the desired dq (the direct and quadrature axis components) the VDC_REF 605 (voltage setpoint to charge the inner DC bus) and VDC_FB 610 (DC bus voltage feedback (voltage measured)) signals are fed to a +/− Subtracter 630 to produce a VDC error value which is sent to DC Voltage Regulator 625. The DC Voltage Regulator 625 outputs an Id command to Summer 640 which also receives an Iq value from Iq Calculator 630. The result of the summed signals is lqd_ref which is Pulse Width Modulated (PWM) by ldq_Regulator 650 to generate an input signal for driving Gate Signal Generator 660 which generates the gate drive signals to switch the switching devices.

FIG. 7 is an illustration of the control structure of the Idq_Regulator 650 of FIG. 6 above. The real and reactive power in a dq frame of reference are given by the following equations:

P=3/2×(Vd·Id)

Q=3/2×(−Vd·Iq)

This shows the real power is mainly a function of the direct component (Id) and the reactive power, a function of the quadrature component (Iq).

Therefore, the “outer “DC voltage control loop can generate the Id to regulate the real power flow. Any real power flow to the internal DC bus will push the voltage up, and any current drawn from the inner DC bus (the DC/DCs drawing current) will reduce the internal DC bus voltage. Controlling the internal DC bus to a fixed level will ensure that the real power flow is controlled.

### Definitions

Idq_REF (710): Current reference for the Grid side current controller.

Grid_Currents (720): These are actual Grid side currents (feedback for the control loop).

Grid_voltages (730): These are Grid side voltages.

PLL_v (735): This block uses the three-phase sinusoidal voltages as inputs and calculates the Grid voltage's phase, frequency, and amplitude.

Iabc-idq (740): This is one or more PI controllers to provide idq feedback values into Iqd_regulator (750).

Idq_Regu (750): From inputs idq_ref and idq_fbk values, this block generates the total reference voltage (Vdq) in dq format.

Vdq0_Vabc (760): This block converts the dq frame voltage references to sinusoidal abc references for the PUVabc modulation block below.

PUVabc (780): This block generates the three signals which are PWD'd by block 790 which goes to the Gate Signal Gen block (660 in FIG. 6).

As to other power services, it is known that active filtering of AC nonlinear loads impact Grid voltage harmonics. The series impedance of transformers can cause excessive distortion on Grid voltages at the point of common coupling (PCC). This can sometimes disable sensitive equipment on the Grid. The resulting harmonics can also cause excessive neutral current and cause more losses at the site. One approach to neutralize some of those harmonics is via voltage-based active filtering as presented below.

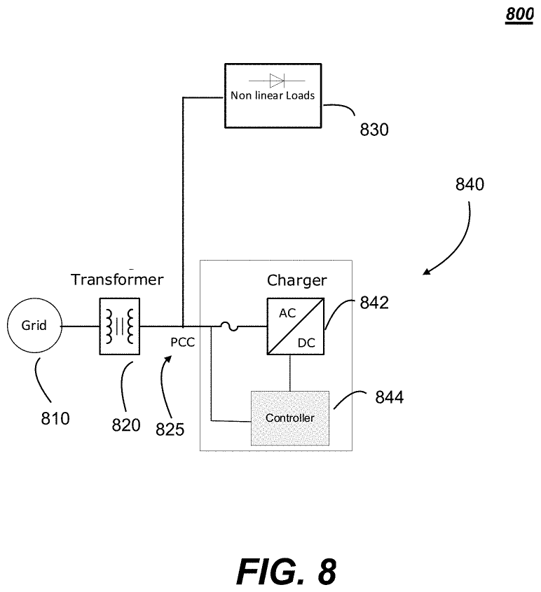

FIG. 8 is an illustration 800 of an exemplary charging system with Grid 810 with transformer 820. charger 840 and a non-linear load 830, joined at PCC 825. Controller 844 is expressly shown in this FIG., though in some embodiments it may be integral to the internals of the AC/DC converter 842, or if remotely controlled, from a remote location. As non-limiting examples, nonlinear loads may be computer power supplies (switched mode power supplies), LED lights, etc. It should be understood that while it may appear this FIG. seems to only illustrate a single channel system, it is of a multi-channel system, the additional channels not being shown for purposes of simplicity and ease of explanation.

Because harmonic currents are distortions of reactive power, the concept here is to supply countering harmonics from the charger 840 so the Grid 810 will not have to provide them. Therefore, AC/DC converter 842 and controller 844 can be used to create offsetting harmonics against the non-linear load 830. In some instances, the controller 844 can be referred to as a Power Control System (PCS) and running attendant software (software modules) to control associated hardware (hardware modules). This will avoid the harmonic drop across the impedance between the Grid 810 and the PCC 825. When the charger 840 is not charging a vehicle, power from the Grid can be shifted, altered in such manner in the exemplary system to supply the offsetting harmonic currents.

The Grid side impedance can also cause another undesirable effect when the load on each phase is not balanced. The voltage drop on the impedance between the Grid and the PCC causes the voltages at PCC to exhibit a significant unbalance. This unbalanced Grid can create a current unbalance in the loads connected to the PCC. One approach to help reduce the imbalance is to inject reactive power to balance out the voltage drops, so the voltages at the PCC become more balanced.

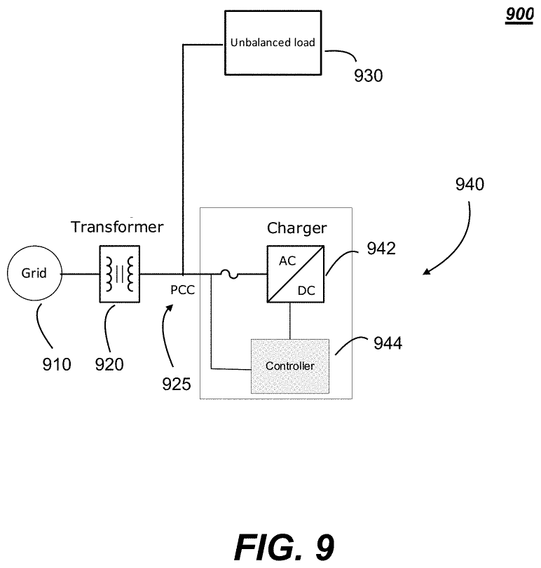

FIG. 9 is an illustration 900 of an exemplary charging system with Grid 910 connected to a transformer 920, charger 940 and unbalanced load 930, sharing PCC 925. AC/DC converter 942 and controller 944 can be used to create offsetting reactive power against the unbalanced load 930. In some instances, the controller 944 can be referred to as the PCS and running attendant software (software modules) to control associated hardware (hardware modules). It should be understood that while it may appear this FIG. seems to only illustrate a single channel system, it is of a multi-channel system, the additional channels not being shown for purposes of simplicity and ease of explanation.

The simplest approach is to perform measurements to determine the unbalance in the Grid 910 or PCC 925. Then, a delta Voltage (reactive or real) can be created by the charger 940 for each phase and injected into PCC 925. Thereafter, the value and level of the injected power can be periodically or by threshold determination, adjusted to minimize the voltage imbalance.

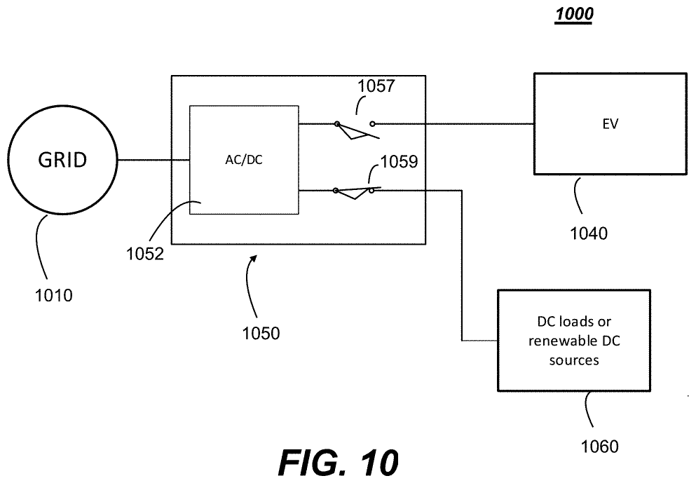

The exemplary system can also operate to facilitate a power source or power sink. For example, FIG. 10 is a high level block diagram 1000 showing an exemplary EV charging system whereby a dual channel approach is utilized. Grid 1010 supplies AC power to a dual channel charger 1250 which has the requisite AC/DC converters, regulators, etc. 1052 and separately controllable contactors 1057, 1059, each contactor providing power to a respectively connected load or source (e.g., EV 1040 and DC source 1060). If management of the contactors 1057, 1059 is properly made, then power into the charger 1050 (and forwarded to Grid 1010 or other device connected to the charger 1050) can be obtained/received from the load-side (e.g., 1060) while the EV 1040 is not being charged. Thus, in some scenarios, real power from an end-connected device or power source can be channeled back to the Grid, as well as reactive power.

For example, the exemplary charger can have one port connected to a DC power source (Photovoltaic, Fuel cell, or Battery bank), etc. and another channel to a battery bank. This provision allows the charger to be used as an Energy Storage System (ESS) with the capability to DC couple a renewable source to the battery for efficient extraction of the renewable power and store it when the charger is not used for charging a vehicle. When charging is required, the burden on the Grid can be reduced by utilizing the power from the stored battery if it is economical.

In view of the examples shown above, it should be appreciated that various other changes and modifications and uses may be contemplated by one of ordinary skill in the art. And, therefore such alternations are understood to be within the scope and purview of this disclosure.

Also, it should be understood that while the above process steps, algorithms or the like may be described in a sequential order, such processes may be configured to work in different orders. In other words, any sequence or order of steps that may be explicitly described does not necessarily indicate a requirement that the steps be performed in that order. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims.

What is claimed is:

1. A multi-channel, multi-mode electric vehicle (EV) AC to DC charger, comprising:
at least two power channels, each power channel containing an AC/DC converter connected to a corresponding DC/DC regulator, wherein each channel is configured to supply DC power to a connected EV;
a controllable bridging switch, connected in parallel between the at least two power channels and disposed before or after the DC/DC regulators, and when closed provides an intermediary path between the at least two power channels;
controllable series switches, connected directly or indirectly after the DC/DC regulators of a respective power channel, and when open provides a break in a power channel output path; and
a controller controlling at least the AC/DC converters, DC/DC regulators, bridging and series switches,
wherein by action of the controller and switches' engagement, the charger can perform at least one of:
(a) charging a connected EV,
(b) directing power from one channel's connected end device to another channel's connected end device,
(c) injecting real or reactive power back to an AC power source,
(d) active AC filtering, and
(e) phase balancing.

2. The charger of claim 1, further comprising, a controllable multipole switch terminating each power channel of the at least two power channels and is controlled by the controller to connect a power channel to its respective EV charging cable or a power channel to a non-EV device.

3. The charger of claim 2, wherein each controllable multipole switch is configured to connect between a non-EV connected channel end device to another non-EV connected channel end device.

4. The charger of claim 1, wherein the AC/DC converter and DC/DC regulator are a single system.

5. The charger of claim 1, wherein the controller is external to at least one of the AC/DC converter and DC/DC regulator.

6. The charger of claim 1, wherein there is a controller for each channel.

7. The charger of claim 1, further comprising, a Line Filter forward of the AC/DC converters.

8. The charger of claim 1, further comprising, a Grid, the Grid coupling AC power to a front end of the charger.

9. The charger of claim 8, further comprising, a reactive power generated from at least an AC converter of at least one power channels, the reactive power being fed into the Grid.

10. The charger of claim 8, further comprising, a connection to a point of common coupling (PCC) between the Grid and the charger.

11. The charger of claim 10, further comprising, at least one of a non-linear load and unbalanced load connected to the PCC.

12. The charger of claim 11, further comprising, at least one of a reactive power and phased power generated from the at least an AC converter of the at least two power channels, the reactive power being fed into the least one non-linear load and unbalanced load.

13. The charger of claim 1, further comprising, a set of controller software instructions to generate reactive power, the instructions containing modules for:
calculating a required total reactive power (Q);
adding a reactive power increment (deltaQ) from a reactive power regulator to obtain a modified reactive power (Q′)
evaluating channel operation status and reactive power levels;
adjusting the modified reactive power (Q′) if needed;
comparing the modified reactive power (Q′) or the adjusted Q′ to a measured or calculated reactive power value; and
sending a signal to the reactive power regulator based on the comparing, to generate a next deltaQ.

14. A method of providing grid-services from a multi-channel, multi-mode electric vehicle (EV) DC charger, comprising:
controlling a charger having at least two power channels, each power channel containing an AC/DC converter connected to a corresponding DC/DC regulator, wherein each channel is configured to supply DC power to a connected EV;
controlling a bridging switch, connected in parallel between the at least two power channels and disposed before or after the DC/DC regulators, and when closed provides an intermediary path between the at least two power channels;
controlling series switches, connected directly or indirectly after the DC/DC regulators of a respective power channel, and when open provides a break in a power channel output path; and
at least one of:
(a) charging a connected EV,
(b) directing power from one channel's connected end device to another channel's connected end device,
(c) injecting real or reactive power back to an AC power source,
(d) active AC filtering, and
(e) phase balancing.

15. The method of claim 13, further comprising, a controlling a multipole switch terminating each power channel of the at least two power channels, wherein the multipole switch operates to connect a power channel to its respective EV charging cable or a power channel to a non-EV device.

16. The method of claim 13, further comprising, connecting via the multipole switch a non-channel connected end device to another non-channel connected end device.

17. The method of claim 13, further comprising, feeding a reactive power generated from at least an AC converter of at least two power channels, into an AC source.

18. The method of claim 13, further comprising, coupling the charger and at least one of a non-linear load and unbalanced load connected to a point of common coupling (PCC).

19. The method of claim 18, further comprising, feeding at least one of a reactive power and phased power generated from the at least an AC converter of the at least two power channels, into the least one non-linear load and unbalanced load.

20. The method of claim 13, further comprising:
calculating a required total reactive power (Q;
adding a reactive power increment (deltaQ) from a reactive power regulator to obtain a modified reactive power (Q′)
evaluating channel operation status and reactive power levels;
adjusting the modified reactive power (Q′) if needed;
comparing the modified reactive power (Q′) or the adjusted Q′ to a measured or calculated reactive power value; and
sending a signal to the reactive power regulator based on the comparing, to generate a next deltaQ.
